(19) United States
(12) Patent Application Publication
(10) Pub. No.: US 2014/0236856 A1
(43) Pub. Date: Aug. 21, 2014

(54) METHODS FOR COORDINATING THE DELIVERY OF PARCELS BY TRAVELERS

(71) Applicant: Jakhongir Baykhurazov, Tashkent (UZ)

(72) Inventor: Jakhongir Baykhurazov, Tashkent (UZ)

(21) Appl. No.: 13/769,190

(22) Filed: Feb. 15, 2013

(51) Int. Cl. G06Q 10/08

(52) U.S. Cl. CPC G06Q 10/0835
USPC 705/336

(57) ABSTRACT

Methods for coordinating the delivery of parcels by travelers, which may include providing shipment data servers storing traveler records associated with potential travelers, receiving from senders traveler queries including desired destination entries associated with locations to which senders desires to send parcels, selecting traveler records including arrival location data consistent with the desired destination data, and providing to the sender contact data associated with suitable travelers. Some examples may include providing shipment data servers storing parcel records associated with potential senders, receiving from potential travelers parcel queries including arrival location entries, selecting parcel records including desired destination data consistent with the arrival location data, and providing to potential travelers contact data associated with suitable parcels. Some examples may include receiving parcels from senders, receiving desired destination locations from senders, receiving payment from senders, providing parcels to travelers, and providing to travelers at least portions of the payment.

### BACKGROUND

The present disclosure relates generally to methods for coordinating the delivery of parcels by travelers. In particular, methods that facilitate sending parcels by making transportation arrangements with travelers already intending to travel to the parcels' intended destinations are described.

Known courier services are not entirely satisfactory for the range of applications in which they are employed. For example, existing courier services fail to utilize the vast number of people that travel daily as a potential means for delivering parcels. Many of these travelers have excess capacity, in which they may be able to transport cargo for others, particularly in exchange for payment.

Further, known courier services are often inadequate at providing last minute, urgent deliveries. Same day or next day delivery is often unavailable or extremely expensive. Because many conventional courier services do not harness the ability of people traveling to distant locations multiple times daily to deliver packages, they fail to capitalize on an excellent resource for increasing the availability and efficacy of urgent deliveries.

In addition, there exists a need for a social network directed to enabling people to deliver parcels as an alternative to conventional, established courier and package delivery services. The current lack of social network directed to parcel delivery limits one's ability to deliver parcels in a number of different ways. For example, conventional courier delivery services are generally inflexible, impersonal, and expensive.

Thus, there exists a need for methods for coordinating the delivery of parcels by travelers that improve upon and advance known couriers' services. Examples of new and useful methods relevant to the needs existing in the field are discussed below.

### SUMMARY

The present disclosure is directed to methods for coordinating the delivery of parcels by travelers, which may include providing shipment data servers storing traveler records associated with potential travelers, receiving from senders traveler queries including desired destination entries associated with locations to which senders desires to send parcels, selecting traveler records including arrival location data consistent with the desired destination data, and providing to the sender contact data associated with suitable travelers. Some examples may include providing shipment data servers storing parcel records associated with potential senders, receiving from potential travelers parcel queries including arrival location entries, selecting parcel records including desired destination data consistent with the arrival location data, and providing to potential travelers contact data associated with suitable parcels. Some examples may include receiving parcels from senders, receiving desired destination locations from senders, receiving payment from senders, providing parcels to travelers, and providing to travelers at least portions of the payment.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 shows a diagrammatic view of shipment data hosted by a shipment data server.

FIG. 4 is a screenshot of a first example of a user interface that may be used in association with the disclosed methods.

FIG. 5 is a screenshot of a second example of a user interface that may be used in association with the disclosed methods.

FIG. 6 is a screenshot of a third example of a user interface that may be used in association with the disclosed methods.

FIG. 7 is a flow diagram of a first example of a method for coordinating the delivery of parcels by travelers.

FIG. 8 is a flow diagram of a second example of a method for coordinating the delivery of parcels by travelers.

FIG. 9 is a flow diagram of a third example of a method for coordinating the delivery of parcels by travelers.

FIG. 10 is a schematic diagram depicting the disclosed methods being used to deliver parcels.

FIG. 11 is a schematic diagram depicting the disclosed methods being used to deliver parcels.

### DETAILED DESCRIPTION

The disclosed methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

In some examples, disclosed methods may connect people who are traveling or scheduled to travel with people who need to send a parcel, such as a document or a package. In some examples, the disclosed methods may facilitate those who urgently need to send a package, which may be impossible or too expensive to do with traditional courier services, such as FedEx®, UPS®, and national postal services. In particular, the disclosed methods may be included as part of a courier connecting service provided by a courier connecting service provider that coordinates transportation between those wanting to send parcels, referred to herein as senders, and those intending to travel, referred to herein as travelers.

In various examples, courier connecting service providers may be any party or service performs features of courier connecting services or other related methods. In some examples, courier connecting services may be independent companies or parties organized specifically to perform disclosed courier connecting services. In some examples, courier connecting services providers may be entities with interests in related markets, including traditional courier services such as FedEx® and UPS®, or other entities with interests that extend beyond providing courier connecting services.

In various examples, travelers may include couriers, frequent fliers, cabin crew members on common carriers, business travelers, or other persons intending to travel in the present or future.

In some examples, courier connecting service providers may establish booths or offices at airports or other transportation hubs. Courier connecting service providers having a presence at transportation hubs allow them to encourage travelers to be couriers and directly compete with traditional courier outposts at those hubs. At these booths or offices, the courier connecting service provider may provide incentives to travelers to transport documents while helping senders find travelers to deliver parcels.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

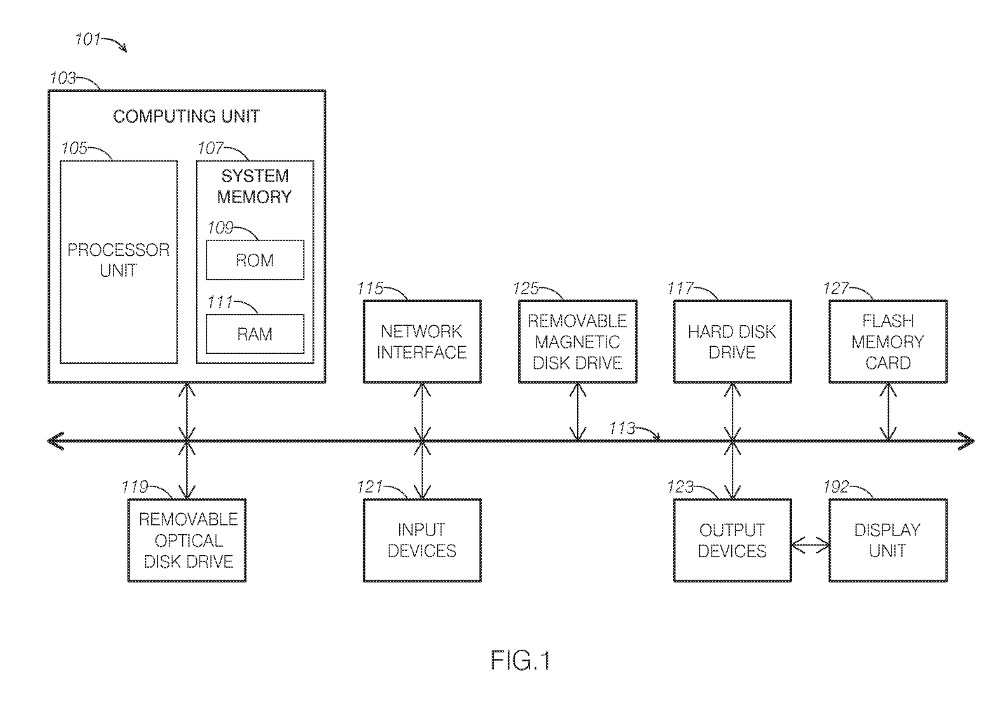

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computing devices may define mobile electronic devices, such as smartphones, tablet computers, or portable music players, often operating the iOS, Symbian, Windows-based (including Windows Mobile and Windows 8), or Android operating systems.

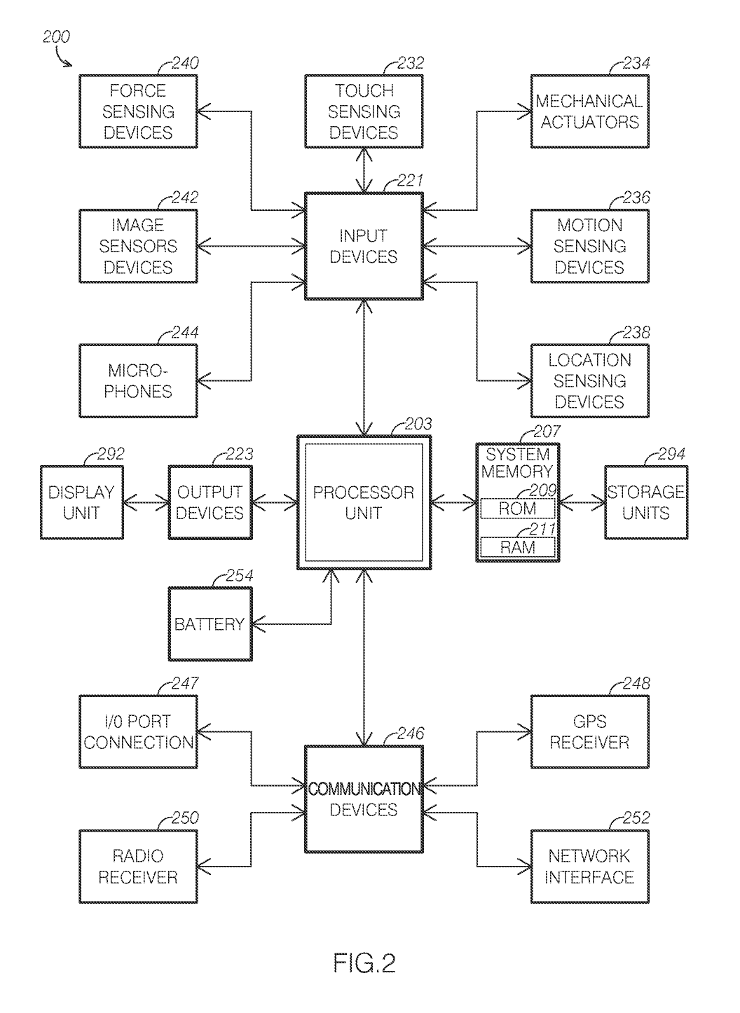

With reference to FIG. 2, an exemplary mobile device, mobile device 200, may include a processor unit 203 (e.g., CPU) configured to execute instructions and to carry out operations associated with the mobile device. For example, using instructions retrieved for example from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well known operating systems such iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include touch sensing devices 232 such as touch screens, touch pads and touch sensing surfaces, mechanical actuators 234 such as button or wheels or hold switches, motion sensing devices 236 such as accelerometers, location detecting devices 238 such as global positioning satellite receivers, WiFi based location detection functionality, or cellular radio based location detection functionality, force sensing devices such as force sensitive displays and housings, image sensors, and microphones. Input devices 221 may also include a clickable display actuator.

Mobile device 200 also includes various output devices 223 that are operatively coupled to processor unit 203. Output devices 233 are configured to transfer data from mobile device 200 to the outside world. Output devices 233 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O port connection 247 that may be wired or wirelessly connected to selected I/O ports such as IR, USB, or Firewire ports, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

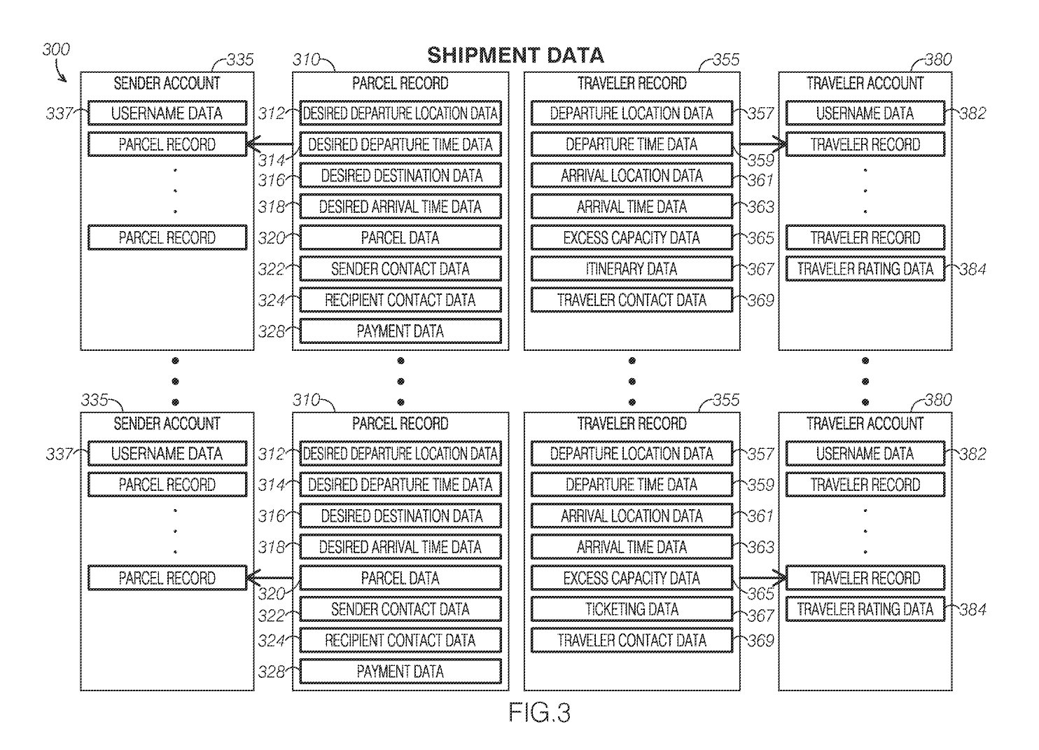

With reference to FIG. 3, some examples of the disclosed methods may include shipment data stored on a shipment data server. FIG. 3 illustrates one example organization of shipment data, shipment dataset 300 that may be used in some example methods for coordinating the delivery of parcels by travelers. As FIG. 3 shows, shipment dataset 300 includes one or more parcel records 310, one or more sender account records 335, one or more traveler records 355, and one or more traveler account records 380.

In some examples, shipment dataset 300 may be hosted by a courier connecting service provider on one or more network-connected computing devices, often at a network location accessible to senders and travelers. Senders and travelers are often able to interface with the hosted shipment data on client computers by accessing this network location with a computing device, such as a client computer operating a web browser.

As FIG. 3 shows, parcel records 310 store data associated with parcels that senders have requested to be sent using the courier connecting service. Each parcel record 310 includes a desired departure location entry 312, a desired departure time entry 314, a desired destination entry 316, a desired arrival time entry 318, a parcel information entry 320, a sender contact information entry 322, a recipient contact information entry 324, and a payment entry 328.

Senders may be, for example, a private individual seeking lower cost or more urgent delivery services compared to commercial courier services (such as FedEx® or UPS®). In some examples, the sender may be businesses or employees thereof.

In some examples, senders may be traditional courier services, such as FedEx® or UPS®. The disclosed methods may allow senders to send parcels with more urgent delivery than traditional courier services' own delivery networks enable. In some examples, a traditional courier service may act as one or both of the sender and the courier connecting service provider. For example, traditional courier services may provide courier connecting services as an “urgent delivery” option.

Parcels may include any type of cargo transportable on commercial transportation carriers, particularly airlines. In some examples, parcels may define packages, documents, or other transportable items. Documents, in some examples, may be limited in size to fit in a substantially flat envelope. By distinguishing between packages and documents, travelers may find easy opportunities to transport documents when they do not have much excess storage capacity in their luggage, briefcases, or other personal items with which they are travelling.

Each desired departure location entry 312 includes desired departure location data defining a location from which the sender desires to send the associated parcel.

In some examples, the desired departure location may be the current or future location or the residence of the sender. In other examples, however, the desired departure location may be other locations. For example, senders, particularly businesses, may request that a remote agent or employee send a document on their behalf.

In various examples, locations may be defined, for example, as cities, states, countries, airports, mailing addresses, physical locations (such as those acquired using a location sensing device of a mobile electronic device), other commonly used geographic designations, or combinations thereof. In various examples, records may be queried or grouped based on locations of various breadths, such as those given above, to allow users to find senders or travelers within an acceptable range of locations.

As FIG. 3 shows, each desired departure time entry 314 includes desired departure location data defining the time at which the sender desires to send the associated parcel from the desired departure location. In some examples, the desired departure time may denote the soonest time that the sender is available to provide the parcel to a traveler.

Each desired destination entry 316 includes desired destination data associated with the location that the sender desires to send the associated parcel. In some examples, the desired destination simply defines a remote location. In some examples, however, the desired destination may be a courier connecting service location at a distant location, which may hold parcels until they are picked up by the recipient.

As FIG. 3 shows, each desired arrival time entry 318 defines the time in which the sender desires to arrive at the desired destination. In some examples, the desired arrival time may be the key factor in determining suitable travelers to transport a parcel. Setting a desired arrival time and desired destination location can, for example, set a deadline that limits suitable travelers to those arriving prior to the deadline.

Each parcel information entry 320 includes parcel data including information about the associated parcel. Parcel data may, for example, include physical characteristic data denoting the weight and geometric dimensions of the parcel.

Parcel data may, additionally or alternatively, include content data including information about the contents of the parcel. For example, the content data may include a description of the contents, whether the parcel is a document or a package, or other identifying criteria as tagging the contents “fragile” or “sensitive.” For parcels defining documents, the content data may additionally include the contained number of pages.

Parcel data may, additionally or alternatively, include parcel transit status data denoting the current transit status of the parcel. Current statuses may include status designations, such as “in transit,” “possessed by traveler,” “delivered,” etc. In some examples, senders may need to be logged in to access the parcel transit data associated with their parcels.

The parcel status transit data may additionally or alternatively include the estimated current location of the parcel. The estimated current location may be acquired by a location sensing device on a mobile electronic device possessed by a traveler or estimated based on published schedule data, such as published air traffic schedules.

As FIG. 3 shows, each sender contact information entry 322 includes sender contact data including the sender's contact information at which the traveler may contact the sender. In some examples, this information is provided to travelers upon agreeing to transport the associated sender's parcel and allows the two parties to further plan the transport.

For the purposes of this disclosure, contact information may include any address that may be used to contact or communicate with the associated party. In some examples, the contact information includes an electronic address to which a traveler may direct electronic communications to contact the sender, such as a phone number or an address on a digital protocol, such as e-mail, a social networking address (including, for example, Twitter® or Facebook® usernames). In additional or alternative examples, contact information includes physical addresses, such as home or business mailing addresses.

In some examples, the courier connecting service may include an electronic messaging service and allows its senders and travelers to communicate with one another. In some examples, senders and travelers may be addressed by their usernames on the associated courier connecting service. In such examples, contact information may of the username data used to address the user on the messaging service.

As FIG. 3 illustrates, recipient contact information entry 324 includes recipient contact data. Recipient contact data includes contact information or instructions directing travelers to a recipient receiving the parcel. In some examples, the contact information includes the address of a recipient or a meeting point, where the traveler is to meet the recipient. In some examples, the recipient contact data identifies a courier connecting service location where the traveler is to deposit the parcel, to be retrieved later.

As FIG. 3 shows, each payment entry 328 includes fee data defining the fee that the sender is willing to pay. In some examples, this is simply a monetary amount. In some examples, the courier connecting service automatically translates fees in foreign transactions according to current currency exchange rates, accepts exchange rate adjusted payments from senders, and/or distributes exchange rate adjusted payments to travelers.

Each payment entry 328 additionally or alternatively includes payment method data defining the sender's preferred method of payment. The payment method data may include credit card information, account information associated with an electronic wallet (such as PayPal®), bank account information, or information associated with other methods of payment commonly used online.

As FIG. 3 shows, shipment dataset 300 includes one or more sender account records 335. As FIG. 3 illustrates, each sender account record 335 may be associated with one or more parcel records 310 and includes a sender username entry 337. Sender account record 335 stores personal information about senders, allowing senders to easily manage their parcel records and simplify future requests to send parcels.

Each sender username entry 337 includes username data associated with the sender. Each sender account record 335 may include a password associated with the username, which may secure some or all of the features associated with the account, such as reviewing parcel records associated with the sender and reviewing the current locations of parcels.

Username data, in some examples, includes an alias, screen name, or other user-selected unique identifier associated with the sender's account. In some sender account examples, username data includes a computer-generated unique identifier, such as a database key.

As FIG. 3 shows, each parcel record 310 includes one or more traveler records 355. Each traveler record 355 includes a departure location entry 357, a departure time entry 359, a arrival location entry 361, a arrival time entry 363, a capacity entry 365, an itinerary entry 367, and a traveler contact information entry 369.

Each traveler record 355 is associated with a traveler who intends to travel from a departure location to an arrival location. In some examples, travelers may be passengers of airlines or other commercial transit services. In some examples, however, travelers may be intending to travel by car, foot, or other individual form of transport.

In some examples, travelers are agents hired by a traditional courier services to send parcels more urgently or cheaper than their transportation network currently allows. In some examples, traditional couriers serve as travelers, using courier connecting services to fill excess capacities on already-scheduled deliveries.

Though many disclosed examples discuss airline passengers, travelers in some examples may simply intend to travel within their city or neighborhood. In more local centered examples, courier connecting services operate as an alternative to document runners or personally delivering parcels locally.

As FIG. 3 shows, each departure location entry 357 includes departure location data associated with a departure location from which the traveler intends to travel. In some examples, the departure location may define the location at which the traveler intends to begin his travel on an associated trip.

In other examples, however, the departure location may define an interim location at which the traveler intends to stop during his travel. By allowing travelers to specify interim locations, courier connecting services may allow multiple travelers to collectively transport a sender's parcel. Travelers working together and traveling on a commercial airline may, for example, meet at an interim location midway through the traveler's trip and exchange the parcel. In some examples, this interim location may be behind a security checkpoint and/or at a courier connecting service location in a transportation hub.

In some examples, travelers' departure location may be automatically generated and updated by cross-referencing itinerary data in itinerary entry 367 with published scheduling data, such as published air traffic schedules.

As FIG. 3 shows, each departure time entry 359 includes departure time data associated with the time at which the traveler is scheduled to depart from his departure location. Like departure location entry 357, this time may be manually entered or automatically generated and updated according to itinerary data in itinerary entry 367.

As FIG. 3 shows, each arrival location entry 361 includes arrival location data associated with the location at which the traveler intends to arrive Like departure location entry 357, arrival location entry 361 may be manually entered or automatically generated and updated according to itinerary data in itinerary entry 367. Further, arrival location entry 361 may similarly define the traveler's final destination or an interim location.

Each arrival time entry 363 includes arrival time data associated with the time at which the traveler is scheduled to arrive Like departure time entry 359, arrival time data may be manually entered or automatically generated and updated according to itinerary data in itinerary entry 367.

As FIG. 3 shows, each capacity entry 365 includes capacity data related to the associated traveler's capacity to carry parcels. In some examples, capacity data may include information that directly corresponds to any category of data stored in parcel information entry 320. For example, capacity data may denote the physical characteristics, content types, and additional information about suitable parcels.

In some examples, some travelers may be willing to check additional luggage to supplement their excess capacity. In such cases, capacity entries may include surcharge data denoting surcharges that travelers will charge to compensate for any airline surcharge for checking additional luggage and the added inconvenience.

Itinerary entry 367 includes itinerary data associated with a traveler's scheduled itinerary with a travel provider. The itinerary data may include travel information, such as flight numbers and schedules. In some examples, the itinerary data may be cross-referenced with published schedules, such as public air traffic schedules, and used to obtain accurate, updated scheduling data associated with departure and arrival locations and times. In some examples, the updated data provides departure location entry 357, departure time entry 359, arrival location entry 361, and arrival time entry 363 with accurate, up to date information.

Each traveler contact information entry 369 includes traveler contact data associated with the traveler's contact information, substantially similar to sender contact information entry 322.

As FIG. 3 shows, shipment dataset 300 includes one or more traveler account records 380. As FIG. 3 illustrates, each traveler account record 380 may be associated with one or more traveler records 355 and includes a traveler username entry 382 and a traveler rating entry 384. Traveler account record 380 stores personal information about travelers, allowing travelers to easily their traveler records and simplify future requests to add traveler records by storing and reusing their personal data.

As FIG. 3 illustrates, each traveler account record 380 includes a traveler username entry 382, substantially similar to the senders' username data stored in sender username entry 337.

Each traveler rating entry 384 includes rating data associated with senders' opinions of the traveler's reliability as a courier. In some examples, this rating data is generated in response to sender feedback provided after the associated traveler delivers (or, at least, is scheduled to deliver) a parcel for the sender.

In some examples, the traveler rating entry uses a rating methodology, which includes senders' feedback. The feedback may include a traveler-reviewable rating and optional textual commentary. In some examples, the rating methodology may consist of a binary “positive” or “negative” rating. In some examples, the ratings and commentary are publicly viewable, allowing both travelers and potential senders to quickly view past senders' levels of satisfaction with selected travelers' services.

In some examples, a single user account operates as both a sender account and a traveler account under a single username. In such examples, the resulting user account record includes all of the elements associated with traveler accounts and sender accounts.

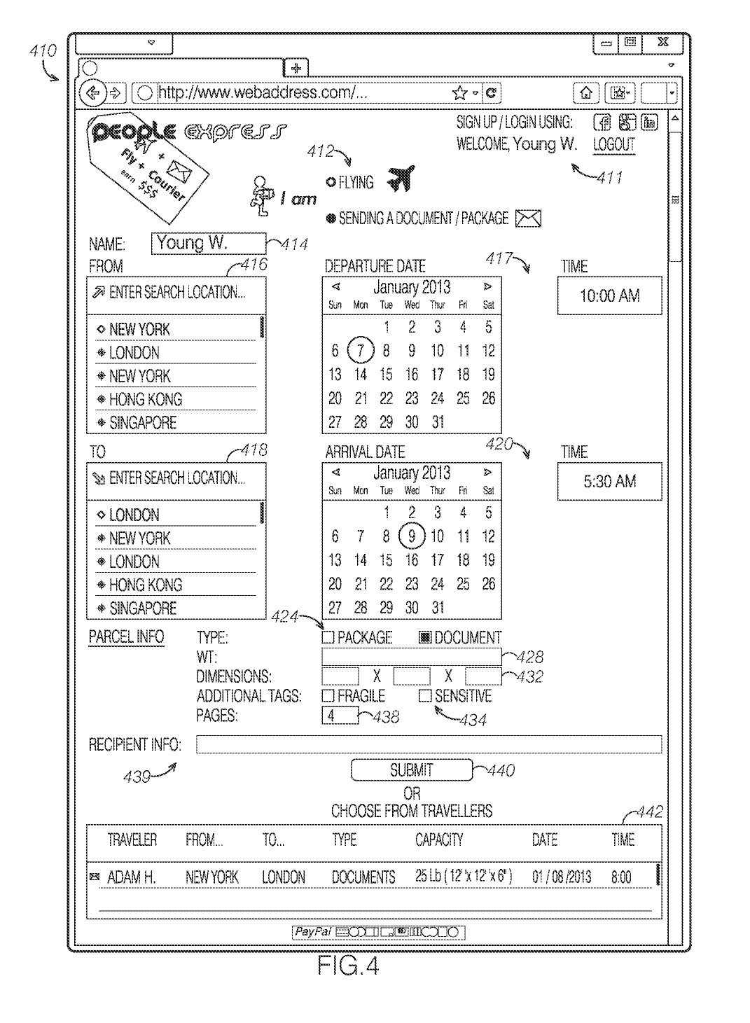

With reference to FIGS. 4-6, some features of the disclosed methods may be implemented through one or more user interfaces. FIGS. 4-6 illustrate example user interfaces, a sender form 410, a traveler form 450, and a quick search form 490, each stored on the shipment data server and sent to users' computing devices to be displayed within web browser windows. These user interfaces allow senders and travelers to review available offers and travelers intending to travel in the future. Further, these user interfaces allow senders and travelers to create new records associated with future trips or offers to transport parcels.

User interface data may, for example, be hosted at a network location accessible to senders and travelers to be sent to users' devices and displayed on a display unit of users' computing devices. For example, the user interface data may be displayed as a standalone website or as an app integrated within a social networking web application. In other examples, user interfaces may be transmitted to users as part of a downloadable mobile or desktop application.

FIG. 4 illustrates sender form 410, one example of a user interface through which potential senders may interface with shipment dataset 300. As FIG. 4 shows, sender form 410 includes a traveler table 442, a login interface 411, a sender name input 414, a desired departure location input 416, a desired departure time input 417, a desired destination location input 418, a desired arrival time input 420, a parcel type entry 424, a parcel weight entry 428, a parcel dimension entry 432, a parcel additional tag entry 434, a parcel page entry 438, a recipient information entry 439, and a submit button 440. In some examples, sender form 410 allows senders to enter data associated with parcels that the senders desire to send to recipients. As FIG. 4 shows, sender form 410 allows potential senders to review a list of traveler records consistent with data entered into sender form 410 and select a suitable traveler for transporting the sender's parcel.

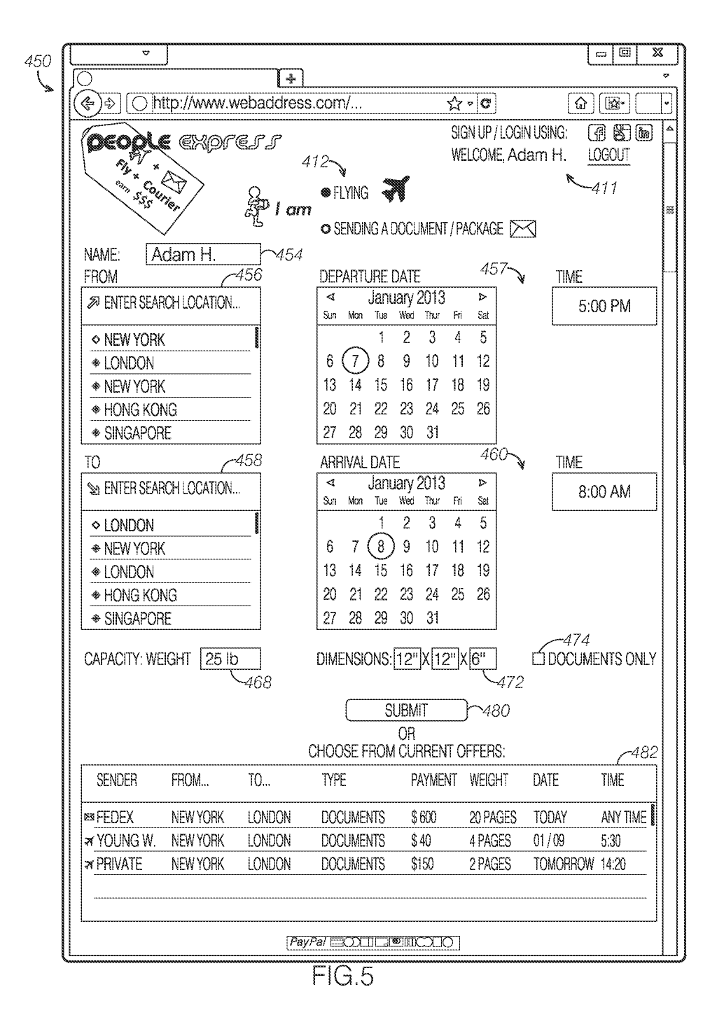

As FIGS. 4 and 5 illustrate, both sender form 410 and traveler form 450 may be displayed on a single, dynamically-updating page that adjusts in response to the users on user type entry 412. For example, sender form 410 may be displayed when a user selects “SENDING A DOCUMENT/PACKAGE” and traveler form 450 may be displayed when a user selects “FLYING.”

With reference to the FIG. 4 example, traveler table 442 is a dynamically updated list of travelers available to send parcels. As FIG. 4 shows and will be described in more depth below, traveler table 442 is updated to reflect the data entered in sender form 410, and sender may easily select a suitable traveler to transport her parcel from the listed travelers.

With reference to the FIG. 4 example, login interface 411 allows users to enter user authentication data to access their accounts. In some examples, logging in may allow access to restricted features. Further, logging in may retrieve and use the user's personal information to automatically enter data. For example, sender name input 414 is automatically filled in with a logged-in sender's publicly viewed name, Young W.

With reference to the FIG. 4 example, sender name input 414 allows senders to enter a publicly viewable name to publicly identify themselves in parcel records. In some examples, this public viewable name is viewable to travelers browsing offers for parcel transport on courier connecting services, as seen in offer table 482 in FIG. 5.

In some examples, senders may enter an alias or “private” into the sender form if the sender would like to remain anonymous until a traveler has agreed to transport his parcel. In such examples, parcel records are still linked to the sender's account, so travelers can still contact the sender upon agreeing to transport the parcel. FIG. 5 illustrates an example of an offer table 482 including a parcel record where “PRIVATE” has been entered in this manner.

With reference to the FIG. 4 example, desired departure location input 416 allows users to enter a departure location from which they desire to send a parcel. When using sender form 410 to create a new parcel record, this data may be stored in desired departure location entry 312.

Further, as FIG. 4 illustrates, traveler table 442 is updated when a user enters data in desired departure location input 416. For example, “NEW YORK” is selected, which limits the results displayed in traveler table 442 to references to traveler records for travelers traveling from New York, US.

As FIG. 4 shows, desired departure location input 416 only allows users to select departure location based on a city to maintain an uncluttered interface. Additional or alternatively, some sender form examples allow senders to search based on various levels of geographic breadth, such as by country, airport, address, or neighborhood. In particular, searching by airport may be particularly useful for reviewing travelers travelling on commercial airlines.

With reference to the FIG. 4 example, desired departure time input 417 allows users to enter a time at which they desire the parcel to be sent from the departure location. When using sender form 410 to create a new parcel record, this data may be stored in desired departure time entry 314. In some examples, desired departure time input 417 defaults to the current date and time to limit displayed travelers to those leaving in the future.

As FIG. 4 shows, traveler table 442 is updated when a user enters data in desired departure time input 417. As FIG. 4 illustrates, January 7 at 10:00 AM, is selected, which limits the results displayed in traveler table 442 to references to traveler records for travelers leaving after that date.

With reference to the FIG. 4 example, desired destination location input 418 allows a sender to enter the destination to which a sender desires to send a parcel. When using sender form 410 to create a new parcel record, this data may be stored in desired destination entry 316. Desired destination location input 418 is substantially similar to desired departure location input 416 and similarly updates traveler table 442. For example, LONDON is selected in FIG. 4, which limits the results displayed in traveler table 442 to references to traveler records for travelers traveling to London, UK.

With reference to the FIG. 4 example, desired arrival time input 420 allows a sender to enter the time at which he desires a parcel to arrive at its destination. When using sender form 410 to create a new parcel record, this data may be stored in desired arrival time entry 318. Desired arrival time input 420 operates substantially similar to desired departure time input 417, but limits results shown in traveler table 442 to those arriving prior to the desired arrival time. For example (as FIG. 4 shows), selecting January 9 at 5:30 AM limits the results displayed in traveler table 442 to traveler records for travelers arriving in London, UK, prior to that time.

With reference to the FIG. 4 example, parcel type entry 424 allows senders to identify parcels as packages or documents. When using sender form 410 to create a new parcel record, this data may be stored in parcel information entry 320. As FIG. 4 illustrates, DOCUMENT is selected, which does not limit the results displayed in traveler table 442. Because packages are larger than documents, it is assumed that any traveler with adequate space to carry a package has adequate space to carry documents. However, if PACKAGE had been selected, the results would eliminate any travelers who indicated that they only have adequate space to carry documents, such as by selecting DOCUMENTS ONLY in traveler form 450 when creating a traveler record.

With reference to the FIG. 4 example, parcel weight entry 428 allows senders to enter the weight of the parcel. When using sender form 410 to create a new parcel record, this data may be stored in parcel information entry 320. Though no data has been entered in parcel weight entry 428, the results displayed would be limited to results with capacities greater than the weight entered in parcel weight entry 428.

With reference to the FIG. 4 example, parcel dimension entry 432 allows senders to enter the geometric dimensions of the entered parcel, including entries for length, width, and height. When using sender form 410 to create a new parcel record, this data may be stored in parcel information entry 320. Though no data has been entered in parcel dimension entry 432, the results displayed would be limited to results with capacities that define length, width, and height dimensions that are each greater than the associated entry in parcel dimension entry 432.

With reference to the FIG. 4 example, parcel additional tag entry 434 allows senders to enter additional information that may need to be conveyed to travelers, such as whether the parcel is “fragile” or “sensitive.” When using sender form 410 to create a new parcel record, this data may be stored in parcel information entry 320. The additional information may be, in some examples, communicated to the traveler prior to transporting the sender's parcel.

With reference to the FIG. 4 example, parcel page entry 438 allows senders to enter the page length of a document. When using sender form 410 to create a new parcel record, this data may be stored in parcel information entry 320. Some examples may allow travelers to enter max numbers of pages for carried documents. In such examples, the results displayed in traveler table 442 may be limited to results with capacity data denoting a max number of pages greater than the number entered in parcel page entry 438.

With reference to the FIG. 4 example, recipient information entry 439 includes recipient contact data that informs the traveler how to contact the recipient. When using sender form 410 to create a new parcel record, this data may be stored in recipient contact information entry 324. In some examples, the recipient contact data may include the recipient's contact information, but this is not required. For example, some recipient contact data may instead provide travelers with a meeting point.

If no traveler is selected in traveler table 442, submit button 440 may submit the data entered in sender form 410 to create a new parcel record associated with the sender's parcel. If the sender has a sender account, the created parcel record may be linked with the sender's sender account record.

If a traveler is selected in traveler table 442, the sender may use submit button 440 to select a traveler to transport his parcel. In such examples, the courier connecting service may provide the sender with contact information associated with the selected traveler.

FIG. 5 illustrates traveler form 450, which represents one example of a user interface that travelers may use to interface with shipment dataset 300. As FIG. 5 shows, traveler form 450 includes an offer table 482, a traveler name input 454, a departure location input 456, a departure time input 457, a destination location input 458, a arrival time input 460, a capacity weight entry 468, a capacity dimension entry 472, a documents only entry 474, and a submit button 480.

Referring to the FIG. 5 example, offer table 482 is substantially similar to traveler table 442 and dynamically updates to list offers from senders that are consistent with the data entered in traveler form 450.

In the FIG. 5 example, traveler name input 454 allows travelers to enter in a publicly viewable name to identify themselves in traveler records. In some examples, travelers may not be allowed to use aliases or anonymous names as senders may to ensure that senders can verify travelers' identities before entrusting them with their parcels. Similar to sender name input 414, traveler name input 454 be automatically entered when a user is logged in.

In some examples, travelers are not allowed to use aliases or anonymous names like “Private,” as senders will want to know the identity of travelers before entrusting them with their parcels. Similar to sender name input 414, traveler name input 454 automatically be entered when a user is logged in.

In the FIG. 5 example, departure location input 456 is substantially similar to desired departure location input 416. Departure location input 456 allows travelers to enter the location from which the traveler intends to travel on an associated trip. When using sender form 410 to create a new traveler record, this data may be stored in departure location entry 357. When data is entered in departure location input 456, offer table 482 is updated to reflect its contents. For example, FIG. 5 illustrates a case where “NEW YORK” is selected, and the results displayed in offer table 482 are limited to offers with a desired departure location of New York, US.

In all traveler schedule-related fields (such as departure/arrival locations and times), the data entered in each input may be automatically generated or updated by receiving an traveler's itinerary for a chosen trip and cross-referencing the received itinerary information entered by the traveler with published schedules, such as air traffic schedules. The received itinerary information may additionally or alternatively be stored in itinerary entry 367.

In the FIG. 5 example, departure time input 457 is substantially similar to desired departure location input 416. Departure time input 457 allows travelers to enter the time at which the traveler intends to depart on an associated trip. When using sender form 410 to create a new traveler record, this data may be stored in departure time entry 359.

When data is entered in departure time input 457, offer table 482 is updated to reflect its contents. FIG. 5 illustrates an example with Jan. 7, 2013, at 5:00 PM, entered in departure time input 457, which limits the results displayed in offer table 482 to references to offers with desired departure data denoting a time before that date.

In the FIG. 5 example, destination location input 458 is substantially similar to desired destination location input 418. Destination location input 458 allows travelers to enter the location to which they intend to travel on an associated trip. When using sender form 410 to create a new traveler record, this data may be stored in departure time entry 359.

When data is entered in destination location input 458, offer table 482 is updated to reflect its contents. As FIG. 5 illustrates, “NEW YORK” is selected, which limits the results displayed in offer table 482 to references to parcel records with desired destination location data associated with London, UK.

In the FIG. 5 example, arrival time input 460 is substantially similar to desired arrival time input 420. Arrival time input 460 allows travelers to enter the time at which the traveler intends to arrive at his destination. When using sender form 410 to create a new traveler record, this data may be stored in arrival time entry 363.

When data is entered in arrival time input 460, offer table 482 is updated to reflect its contents. FIG. 5 illustrates an example where Jan. 8, 2013, at 8:00 AM, is entered, which limits the results displayed in offer table 482 to references to parcel records with a desired arrival time after that date.

As FIG. 5 shows, traveler form 450 includes capacity dimension entry 472 and capacity weight entry 468, which allows travelers to specify the maximum geometric dimensions and weight of parcel that they would be willing to transport. When using sender form 410 to create a new traveler record, this data may be stored in capacity entry 365. In some examples, the figures entered (or those stored in capacity entry 365) may be automatically adjusted in response to the traveler accepting offers for the associated trip.

When data is entered in capacity dimension entry 472, offer table 482 is updated to reflect its contents. FIG. 5 illustrates an example wherein offer table 482 displays only parcel records with parcel data denoting geometric dimensions and weight lesser than the entered dimensions and weight.

In the FIG. 5 example, a traveler may use documents only entry 474 to indicates that he has capacity to carry only documents and not packages. In some examples, the traveler is additionally able to specify the amount of pages he has capacity to transport when the traveler indicates that he is willing to transport documents. When selected, offer table 482 is adjusted to only include parcel records associated with documents.

In the FIG. 5 example, submit button 480. If no offer is selected in offer table 482, a user may select submit button 480 to submit the data entered in traveler form 450 and create a new traveler record associated with the entered data. If the sender has a traveler account, the created parcel record may be linked with the traveler's account.

If an offer is selected in offer table 482, the sender may use submit button 480 to agree to transport a sender's parcel for the offered price. In such examples, the courier connecting service may provide the traveler or the sender with contact information associated with the sender associated with a selected offer.

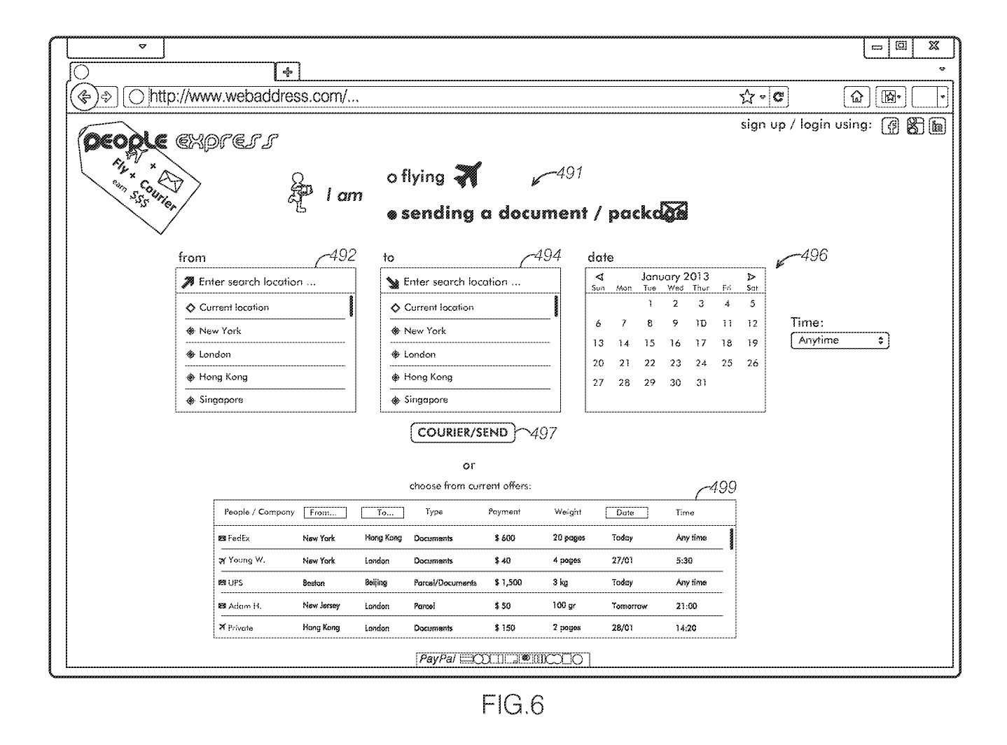

FIG. 6 illustrates a third example of a user interface, quick search form 490. As FIG. 6 illustrates, quick search form 490's interactive elements consist of a login entry 493, a user type entry 491, a departure location entry 492, an arrival location entry 494, a quick time entry 496, a submit button 497, and a quick dynamically-updating table 499.

Each of the elements of quick search form 490 act substantially similar to the corresponding elements in either sender form 410 or traveler form 450. In particular, the behavior of each element may adjust to correlate with the user's selection in user type entry 491. For example, departure location entry 492, arrival location entry 494, quick time entry 496, submit button 497, and quick dynamically-updating table 499 operate like the corresponding elements of sender form 410 when user selects “SENDING A DOCUMENT/PACKAGE” in user type entry 491. Similarly, departure location entry 492, arrival location entry 494, quick time entry 496, submit button 497, and quick dynamically-updating table 499 operate like the corresponding elements of traveler form 450 when user selects “FLYING” in user type entry 491.

Quick search form 490 provides a simple, intuitive, mobile friendly interface that allows users to quickly find available offers or travelers. Quick search form 490's simple interface may, for example, make it easier for travelers to find offers near their departure time, perhaps even when at the airport.

Login entry 493 may further accelerate this process by, for example, instructing the courier connecting service to retrieve stored account data and auto-enter some of the required information. In particular, this may be useful for billing information.

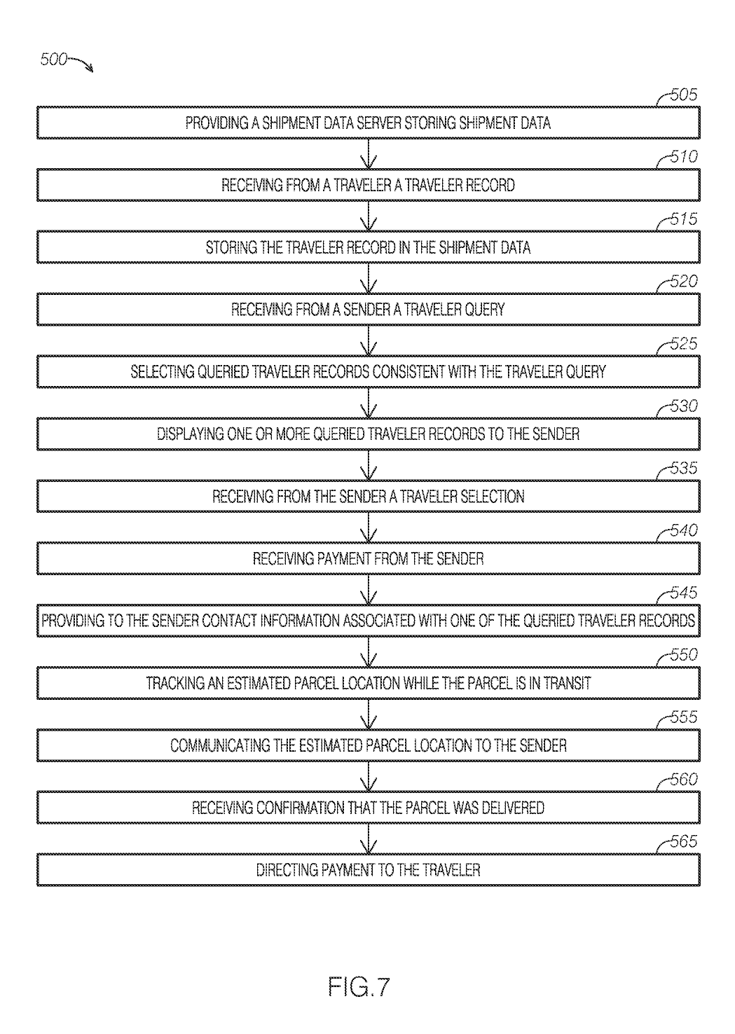

With reference to FIG. 7, an example of a method for coordinating the delivery of parcels by travelers, method 500, will now be described. By performing some or all of method 500, a courier connecting service provider may facilitate senders in sending parcels to a destination by the senders a means for contacting travelers who has pre-existing intentions to travel to the destination.

As FIG. 7 illustrates, a shipment data server storing shipment data is provided at step 505. The shipment data server may be hosted on one or more network connected computing devices. The shipment data server may, for example, store shipment data, such as shipment dataset 300, and user interface data, such as the data configured to generate sender form 410, traveler form 450, and quick search form 490.

In some examples, users connect to the shipment data server to interact with the shipment data using client computers displaying user interfaces, such as web pages, associated with the user interface data. Connected users may additionally or alternatively use downloadable mobile applications to connect and interface with the shipment data server.

As FIG. 7 shows, a traveler record is received at step 510. In some examples, one or more traveler records may be received at step 510. In some examples, the received traveler data may be received in response to user input entered on traveler form 450. If the user is logged in, the traveler record may additionally be associated with the traveler's account.

As FIG. 7 illustrates, the received traveler record is stored in the shipment data at step 515. Received traveler records are stored in an organization that reflects FIG. 3's traveler dataset, including a plurality of traveler records. Each traveler record may be, but is not required to be, associated with a traveler account. In some examples, traveler accounts may be associated with one or more traveler records, but traveler records may only be associated with one traveler account. In some examples, travelers may associate multiple traveler records with regard to a single trip, such as when travelers accept multiple offers for delivery on that trip.

Further, multiple traveler records may be associated with a single parcel, allowing parcels to be exchanged at interim points during travelers' trips. These interim exchanges may include, for example, providing the parcel to a courier connecting service provider at the interim location, where it is held to be provided to a second traveler associated with the parcel.

As FIG. 7 shows, traveler query is received from a sender at step 520. The traveler query may be entered into sender form 410, as described above. Because traveler table 442 updates dynamically in response to data entered in sender form 410, traveler queries may be persistently received as sender form 410 enters data into sender form 410.

As FIG. 7 illustrates, queried traveler records consistent with the traveler query are selected at step 525. In dynamically updating traveler table 442 in response to the traveler queries persistently received through sender form 410, the shipment data server is persistently selecting queried traveler records consistent with the traveler query. As FIG. 4 shows, the records illustrated in traveler table 442 all include data that is consistent with the traveler query according to the strict criteria described above in the discussion of sender form 410.

Records do not need to perfectly match each of filled entries on sender form 410 in the manner described above to be consistent with traveler queries. Rather, some examples may build in a reasonable margin of error on for each of the criteria limiting the queried traveler records. In other examples, sets of queried traveler records may fall outside the specific entered ranges but be close enough to define an acceptable difference. For example, a sender may request travelers with capacity for a 26 pound parcel and traveler table 442 may return, for example, travelers that denoted a 25 pound capacity. The values of reasonable margins of error may be by shipment data server administrators in some examples. In some examples, user interfaces may provide an entry that allows travelers or senders to expressly enter a reasonable margin of error value associated with one or more of traveler records' entries.

As FIG. 7 shows, one or more queried traveler records are displayed to the sender at step 530. As FIG. 4 illustrates, the queried traveler records are dynamically updated in traveler table 442, which is displayed to the sender on a display unit of a computing device operated by the sender.

As FIG. 7 illustrates, a traveler selection is received from the sender at step 535. FIG. 4 displays an example wherein the sender is able to select a traveler by selecting a queried traveler record in traveler table 442 and selecting submit button 440.

As FIG. 7 shows, payment is received from the sender at step 540. Payment may be received, for example, by charging a credit card associated with the sender's account, charging a credit card entered by the sender, receiving funds from a user's online wallet account (such as PayPal), or other methods commonly used to accept payment online. Payment may, in some examples, be received from the sender after selecting a traveler selection

In some examples, received funds may be held in escrow by the courier connecting service and withheld from the traveler until receiving confirmation that the parcel was satisfactorily delivered to the recipient. By withholding funds until receipt of the parcel is confirmed, courier connecting services may encourage travelers to perform satisfactory deliveries.

Payment may be, in some examples, non-monetary. For example, senders, or agents on their behalf, may provide payment in the form of flight upgrades, discounted flights, reward points or miles, or other forms of non-monetary payment, which may be conveyed to travelers upon satisfactory delivery.

The contact information associated with one of the queried traveler records is provided to the sender at step 545. In some examples, providing the contact information may include providing the sender the contact information of a traveler selected in traveler table 442. In some examples, the sender may use this contact information to initiate two-way communication with the traveler and allow the sender to coordinate the traveler's receipt and delivery of the parcel.

In some examples, providing the sender contact information may include or consist of automatically contacting a selected traveler, such as by sending an electronic communication to the selected traveler upon the sender's selection.

As FIG. 7 shows, an estimated parcel location is tracked while the parcel is in transit at step 550. In some examples, tracking the estimated parcel location may include receiving from a traveler's mobile electronic device positional data acquired with a location sensing device of the mobile electronic device. In some examples, the location sensing device may define a GPS receiver or other common smartphone geolocating feature.

Additionally or alternatively, tracking the estimated parcel location may include electronically accessing and translating published schedule data associated with a common carrier with whom the traveler intended to travel. For example, the schedule data, such as published air traffic schedules, may be cross-referenced with a traveler record's itinerary data to determine the approximate location of the parcel when in transit. This may be particularly useful when mobile communication is unavailable, such as during air travel.

As FIG. 7 illustrates, the estimated parcel location is communicated to the sender at step 555. In some examples, the user interface may have a tracking form associated with a parcel record configured to display the estimated location of the associated parcel. In some examples, senders may need to be logged in to view the tracking forms associated with their parcels in transit.

As FIG. 7 shows, confirmation that the parcel was delivered is received at step 560. In some examples, this confirmation is sent to the courier connecting service by the recipient, such as by communicating an authentication code via a mobile electronic or other computing device. In other examples, this confirmation may be sent by a courier connecting service location at the destination location.

As FIG. 7 illustrates, payment is directed to the traveler at step 565. Upon receiving proper notification that a parcel has been satisfactorily delivered, the courier connecting service directs the funds to the traveler in a traveler-directed manner. Often, payment is directed the traveler's bank account or to an electronic wallet (such as PayPal).

In some examples, the sender has no authority to prevent the funds from being transferred upon the delivery being accepted. In some examples, however, the sender may prevent payment from being completed upon discovering that the delivery was unsatisfactory.

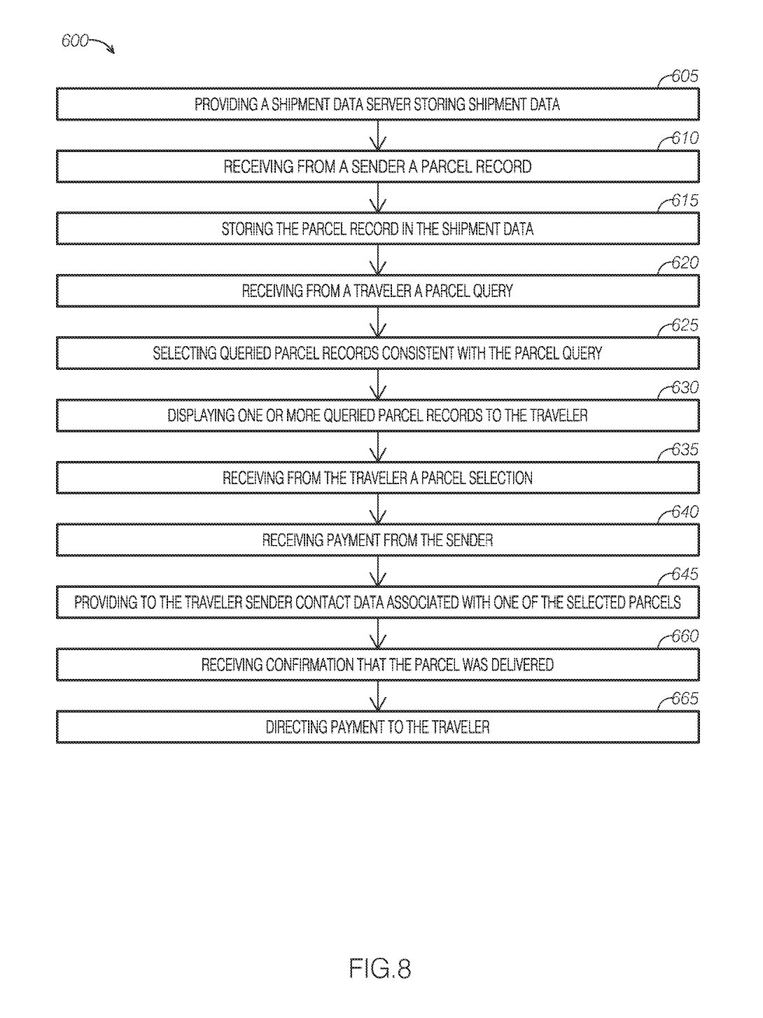

With reference to FIG. 8, an example of a method for coordinating the delivery of parcels by travelers, method 600, will now be described. Method 600 is similar, in many ways, to method 500. Method 600, however, focuses on using the courier connecting service from the traveler's perspective.

As FIG. 8 illustrates, a shipment data server storing shipment data is provided at step 605. Step 605 is substantially similar to providing the shipment data server at step 505.

As FIG. 8 shows, a parcel record is received from a sender at step 610. The parcel record may be received from a user entering data on a user interface, such as sender form 410. The created parcel record reflects the data entered in sender form 410. If the user is logged in, the parcel record may additionally be associated with the sender's account.

As FIG. 8 illustrates, the parcel record is stored in the shipment data at step 615. As FIG. 3 shows, parcel records are stored within a traveler dataset including a plurality of parcel records. Each parcel record may be, but is not required to be, associated with a sender account. In some examples, sender accounts may be associated with one or more parcel records, but parcel records may only be associated with one sender account.

As FIG. 8 shows, a parcel query is received from a traveler at step 620. The parcel query may be entered in traveler form 450, similar to the traveler query entered in sender form 410 in step 520. Similarly, offer table 482 updates dynamically in response to input in traveler form 450 to illustrate a list of offers that are consistent with the values entered in traveler form 450. As result, sender queries are received persistently as the traveler enters data into traveler form 450

As FIG. 8 illustrates, queried parcel records consistent with the parcel query are selected at step 625. Similar to traveler table 442, offer table 482 is dynamically updated in response to the traveler queries persistently received through traveler form 450 and the shipment data server persistently selects and returns queried traveler records consistent with the traveler query.

Similar to method 500, the values returned and displayed in traveler table 442 need not strictly follow the criteria discussed in association with traveler form 450 in all examples, and may in some examples account for a reasonable margin of error.

As FIG. 8 shows, one or more queried parcel records are displayed to the traveler at step 630. As FIG. 4 illustrates, the queried parcel records are dynamically updated in offer table 482, where they are displayed to the traveler.

As FIG. 8 illustrates, a parcel selection is received from the traveler at step 635. FIG. 4 displays, for example, a user interface allowing the traveler is able to select an offer by selecting a queried parcel record in offer table 482 and selecting submit button 480.

As FIG. 8 shows, payment is received from the sender at step 640. In some examples, the courier connecting service receives payment from the sender, to be held in escrow until delivery confirmation, similar to at step 540. By accepting funds at the time that the sender submits a request for a parcel to be transported, the courier connecting service may ensure that funds are available to travelers when they agree to transport a parcel.

Sender contact data associated with one of the selected parcels is provided to the traveler at step 645 substantially similar to step 545, but the traveler is provided with the sender's contact information. Thus, the traveler initiates communication in this instance, rather than the sender.

As FIG. 8 illustrates, confirmation that the parcel was delivered is received at step 660, substantially similar to step 560

As FIG. 8 shows, payment is directed to the traveler upon confirmation of delivery at step 665, substantially similar to step 565.

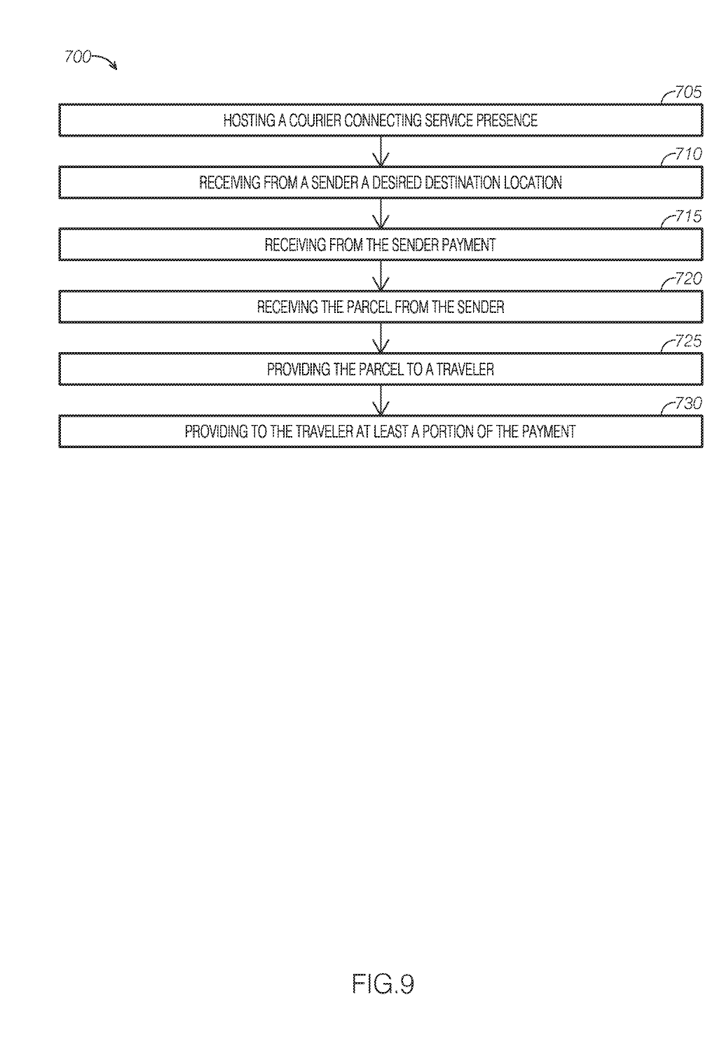

With reference to FIG. 9, an example of a method for coordinating the delivery of parcels by travelers, method 700, will now be described. Method 700 is similar, in many ways, to method 500 and method 600. Method 700 illustrates the use of courier connecting service locations at or near transportation hubs to further facilitate connecting senders with travelers. Method 700 additionally may illustrate that novel features of the disclosed invention may be used without computers and/or software.

As FIG. 9 illustrates, a courier connecting service location is hosted at or near a transportation hub at step 705. The courier connecting service location may, for example, include a retail location, office, booth, etc., where employees of the courier connecting service provider may assist senders and travelers.

In some examples, courier connecting service locations are located at or near a transportation hub. In some examples, courier connecting service locations are located in airport lobbies or in retail locations located outside, but near, the airport. In particular, some courier connecting service locations may be located behind security checkpoints to facilitate interim exchanges.

In some examples, courier connecting service locations attempt to recruit travelers by, for example, offering incentives to nearby travelers to lure them to agree to transport parcels. In some examples, these incentives are additional to any fee that would be received for transporting a parcel.

In some examples, courier connecting service locations may possess parcels provided by senders that are ready to be provided to a suitable traveler. In such examples, courier connecting service locations serve as agents for the sender, finding last-minute, suitable travelers as they are in the airport for their departure.

In some examples, courier connecting service locations receive parcels on behalf of senders or recipients. Upon receipt, courier connecting service locations may hold the parcels until it is convenient for a recipient to collect the parcel. This may make scheduling easier on both the recipient and the traveler and relieve the traveler of the responsibility of finding the recipient.

In some examples, courier connecting service providers with courier connecting service locations provide courier connecting services that include host network accessible shipment data servers accessible through user interfaces, similar to shipment dataset 300, sender form 410, traveler form 450, and quick search form 490. In such examples, the courier connecting service provider may, at the courier connecting service location, collect and distribute parcels amongst senders and travelers who made previous arrangements through the shipment data server and associated interfaces.

Further, in some examples, courier connecting service locations may include courier connecting service terminals, such as network connected computing devices, which may be used by nearby parties to access shipment data servers and associated user interfaces. In particular, courier connecting services may include publicly accessible kiosks through which senders and travelers may access, view, and/or modify their associated accounts, parcel records, and/or traveler records. Additionally or alternatively, courier connecting service terminals may allow parties to access, display, and modify accounts and records on a courier connecting service hosted by a different courier connecting service provider.

As FIG. 9 shows, a desired destination location is received from a sender at step 710. The desired destination location defines a location to which the sender desires to send a parcel. In some examples, this information may be received from a sender upon providing the courier connecting service location with the parcel.

As FIG. 9 shows, payment for delivering the parcel is received from the sender at step 715. In some examples, courier connecting service locations may simply ask for a fee that the sender is willing to pay and receives cash or credit card payment from the sender. As with previously described examples, this amount may be held in escrow until the sender's parcel is finally delivered.

As FIG. 9 illustrates, the parcel is received from the sender at step 720. In some examples, the parcel may be received by a courier connecting service location at a transportation hub, such as an airport. In other examples, the parcel may be received by a traveler located at or near a courier connecting service location. In some examples, the parcel may be held until a suitable traveler is found by the courier connecting service.

Around the time of receiving the parcel (or after receiving the parcel), the courier connecting service may also receive payment and a desired destination associated with the parcel.

As FIG. 9 shows, the parcel is provided to a traveler, who may have a pre-existing intention to travel to the desired destination location, at step 725. In some examples, the parcel may be provided, at the transportation hub, at or near the courier connecting service location. In some examples, the sender may hand the parcel over directly to the traveler.

In some examples, the sender may have already selected a suitable traveler, and the courier connecting service holds the parcel until the suitable traveler arrives at the courier connecting service location. In other examples, the courier connecting service may select a suitable traveler on behalf of the sender.

As FIG. 9 illustrates, at least a portion of the payment is provided to the traveler for delivering the parcel upon receiving confirmation that the parcel was satisfactorily delivered at step 730. In some examples, the traveler receives all of the payment. In other examples, however, the courier connecting service retains of portion of the payment as a service fee.

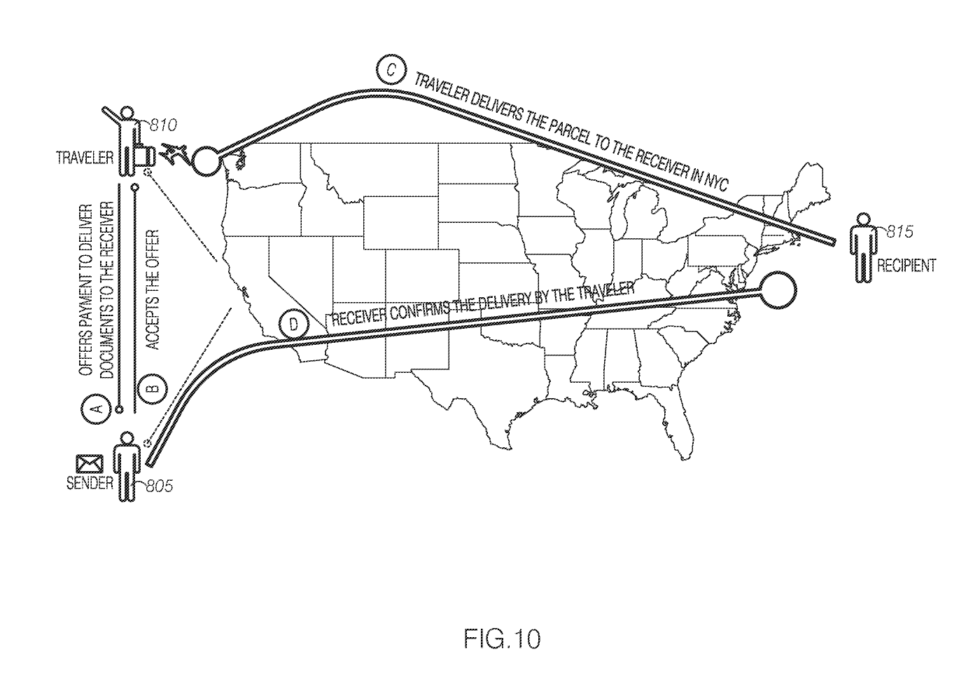

FIG. 10 provides a diagram showing an example use case where features of the disclosed methods may be used. For example, FIG. 10 illustrates a sender 805, located in Los Angeles, who urgently needs to send a document to New York City, and a traveler 810, also located in Los Angeles, who had intentions of flying to New York City on a commercial airline prior to ever meeting the sender.

In step A, the sender offers payment to the traveler to deliver the documents to a recipient 815, who is located in New York City. In step B, the traveler agrees to deliver the documents, and subsequently receives the parcel from the sender. In step C, traveler travels to New York City, as he was already planning on doing, and delivers the documents to recipient 815. At step D, recipient 815 confirms to sender 805 the parcel was delivered. At this point, sender 805 finalizes payment to traveler 810. In this example, sender 805 may have been able to deliver his documents to New York City in a more timely fashion than traditional courier services may allow.

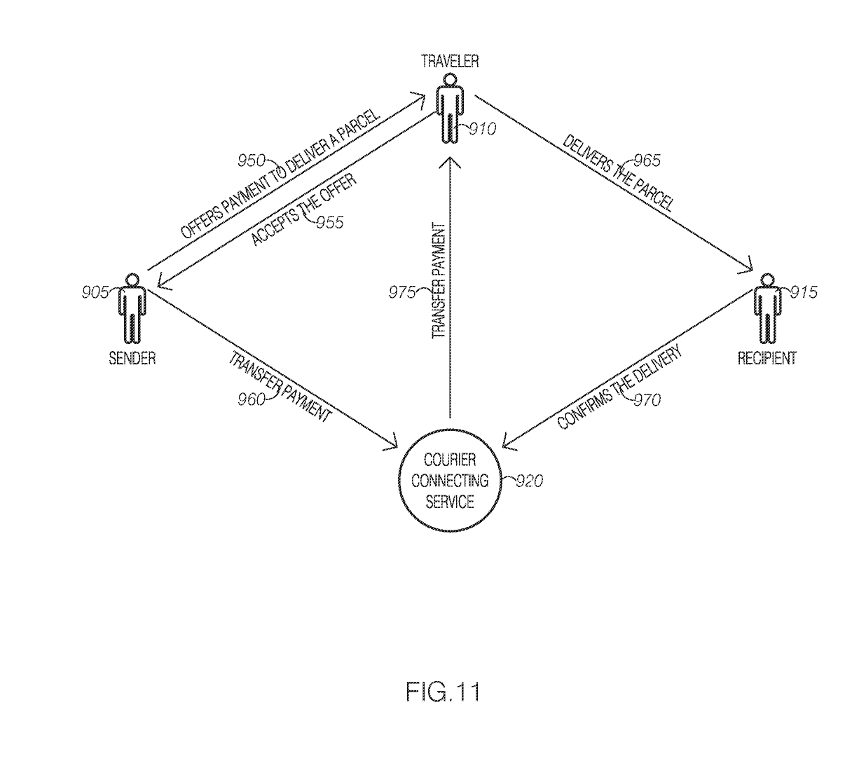

FIG. 11 illustrates an additional flowchart illustrating one example method that incorporates some of the novel features of the disclosed methods. FIG. 11 illustrates the interactions between a sender 905, a traveler 910, a recipient 915, and a courier connecting service 920. In a first step 950, sender 905 offers payment to traveler 910 to deliver a parcel. In a second step 955, traveler 910 accepts the offer. Upon the traveler accepting the offer, payment is transferred to courier connecting service 920 at step 960, the payment to be held in escrow until receiving confirmation of delivery. Traveler 910 delivers the parcel to recipient 915 at step 965. Recipient 915 confirms deliver to courier connecting service 920 at step 970. Upon receiving confirmation of deliver, courier connecting service 920 directs at least a portion of the funds held in escrow to traveler 910 to pay for the delivery at step 975.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for coordinating the delivery of parcels by a traveler, comprising:
providing a shipment data server storing one or more traveler records, each traveler record associated with a potential traveler and including:
an arrival location entry including arrival location data associated with an arrival location to which the potential traveler intends to travel; and
a traveler contact entry including traveler contact data, the traveler contact data providing an address for a sender to direct electronic communications to contact the potential traveler;
receiving from the sender a traveler query including a desired destination entry, the desired destination entry including desired destination data associated with a desired destination location to which the sender desires to send a parcel;
selecting, with a processor executing computer executable instructions, traveler records including arrival location data consistent with the desired destination data to define a set of suitable travelers; and
providing to the sender, in response to the traveler query, the traveler contact data associated with the travelers in the set of suitable travelers.

2. The method of claim 1, wherein the traveler is under no obligation to deliver the parcel due to a pre-existing relationship with a parcel delivery service.

3. The method of claim 1, wherein:
one or more traveler records define a departure location entry including departure location data associated with a departure location from which the potential traveler intends to travel;
the traveler query includes a desired departure location entry, the desired departure location entry including desired departure location data associated with a desired departure location from which the sender desires to send the parcel; and
the traveler data associated with the travelers in the set of suitable travelers define departure location data consistent with the desired departure location data.

4. The method of claim 3, further comprising providing user interface data configured to be communicated to a computer system operated by the sender and instruct the computer system to display a user interface on a display unit of the computer system operated by the sender, the user interface including:
a desired departure input configured to receive desired departure location data from the sender; and
a desired destination input configured to receive desired destination data from the sender; and a traveler table simultaneously displaying traveler data associated with one or more queried traveler records.

5. The method of claim 1, wherein:
one or more traveler records define an arrival time entry including arrival time data associated with an arrival time at which the potential traveler is scheduled to arrive at the destination;
the traveler query includes a desired arrival time entry, the desired arrival time entry including desired arrival time data associated with a desired arrival time at which the sender desires to send the parcel to be received; and
the traveler data associated with the travelers in the set of suitable travelers define arrival time data consistent with the desired arrival time data.

6. The method of claim 1, wherein:
one or more traveler records define an departure time entry including departure time data associated with a departure time at which the potential traveler is scheduled to leave a departure location;
the traveler query includes a desired departure time entry, the desired departure time entry including desired departure time data associated with a desired departure time at which the sender desires the parcel to be sent; and
the traveler data associated with the travelers in the set of suitable travelers define departure time data consistent with the desired departure time data.

7. The method of claim 1, further comprising communicating electronically to the sender an estimated parcel location associated with the parcel when the parcel is possessed by the traveler.

8. The method of claim 7, further comprising tracking the estimated parcel location by receiving from a mobile electronic device possessed by the traveler data acquired with a location sensing device of the mobile electronic device.

9. The method of claim 7, further comprising tracking the estimated parcel location by electronically accessing and translating published schedule data associated with a common carrier with whom the traveler intended to travel.

10. The method of claim 1, further comprising:
receiving payment data from the sender; and
directing a fee, in a manner directed by the payment data, to a selected traveler upon successful delivery of the parcel.

11. The method of claim 1, further comprising:
receiving recipient contact information from the sender; and
communicating the recipient contact information to a selected traveler, the selected traveler selected by the sender from the set of suitable travelers.

12. The method of claim 1, further comprising holding the parcel for at the arrival location.

13. The method of claim 1, wherein the shipment data server includes one or more traveler account records, each traveler account record associated with a potential traveler and includes traveler rating data associated with the sender's level of satisfaction with the traveler's performance; and
further comprising:
receiving from the sender a sender rating associated with a selected traveler after the selected traveler has delivered the parcel; and
adjusting the traveler rating data in response to the sender rating.

14. A method for assisting parcel transport, comprising:
providing a shipment data server storing one or more parcel records, each parcel record associated with a potential sender desiring to ship a parcel and including:
a desired destination entry including desired destination data associated with a destination to which the sender desires to send the parcel; and
a sender contact entry including sender contact data, the sender contact data providing an address at which a potential traveler may contact the sender;
receiving from the potential traveler a parcel query including an arrival location entry, the arrival location entry including arrival location data associated with an arrival location to which the potential traveler intends to travel;
selecting, with a processor executing computer executable instructions, parcel records including desired destination data consistent with the arrival location data to define a set of suitable parcels; and
providing to the potential traveler, in response to the parcel query, the sender contact data associated with the parcels in the set of suitable parcels.

15. The method of claim 14, further comprising providing user interface data configured to be communicated to a computer system operated by the sender and to instruct the computer system to display a user interface on a display unit of the computer system operated by the sender, the user interface including a parcel table simultaneously displaying parcel data associated with one or more queried parcel records.

16. The method of claim 15, wherein:
one or more parcel records include a parcel information entry including parcel data, the parcel data including physical characteristic data denoting, at least, a weight of the parcel and geometric dimensions of the parcel; and
the parcel table displays the parcel data associated with each queried parcel record.

17. The method of claim 15, wherein:
one or more sender records include a parcel information entry including parcel data, the parcel data corresponding to physical characteristics of the parcel;
the parcel query includes an excess capacity entry including excess capacity data associated with physical characteristics of a potential parcel that the potential traveler is willing to transport; and
the queried parcel records define parcel data associated with parcels with physical characteristics smaller than the potential parcel.

18. A method for assisting parcel transport, comprising:
receiving a parcel from a sender;
receiving from the sender a desired destination location to which the sender desires to send the parcel;
receiving from the sender a payment for delivery of the parcel;
providing the parcel to a traveler; and
providing to the traveler at least a portion of the payment for delivering the parcel upon receiving confirmation that the parcel was satisfactorily delivered.

19. The method of claim 18, further comprising hosting a courier connecting service location at or near a transportation hub; and
wherein the parcel is provided, at or near the courier connecting service location, to the traveler and from the courier connecting service location.

20. The method of claim 18, further comprising hosting a courier connecting service location at a transportation hub; and
wherein the parcel is received, at the transportation hub, from the sender and by the courier connecting service location.
